(19) United States
(12) Patent Application Publication
(10) Pub. No.: US 2009/0199229 A1
(43) Pub. Date: Aug. 6, 2009

(54) SYSTEM FOR PROVIDING ADVERTISEMENTS ACROSS MULTIPLE CHANNELS

(75) Inventors: Arvind Gupta, San Carlos, CA (US); Ashutosh Tiwari, Studio City, CA (US); Gopalakrishnan Venkatraman, Campbell, CA (US); Dominic Cheung, South Pasadena, CA (US); Stacy R. Bennett, Pasadena, CA (US); Douglas B. Koen, Austin, TX (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/026,522

(22) Filed: Feb. 5, 2008

(51) Int. Cl. H04N 7/025

(52) U.S. Cl. 725/32

(57) ABSTRACT

A system is described for providing advertisements across multiple channels. The system may include a processor, a memory and an interface. The memory may store advertisements and a request. The interface may be operatively connected to the memory and the processor and may communicate with a user. The processor may be operatively connected to the interface and the memory and may associate the advertisements with channels. An advertisement associated with a channel may be formatted for display on the channel. The processor may receive a request from the user via the interface. The processor may determine the channel associated with the request and retrieve an advertisement associated with the channel. The processor may provide the advertisement to the user via the interface.

### TECHNICAL FIELD

The present description relates generally to a system and method, generally referred to as a system, for providing advertisements across multiple channels, and more particularly, but not exclusively, to providing an advertisement campaign management system supporting multiple advertisement delivery channels.

### BACKGROUND

Many advertisers may maintain web advertising campaigns. Web advertising may allow the advertisers to reach users via web pages. In addition to web advertising, new channels for delivering online advertising may be emerging, such as mobile advertising, Internet Protocol Television (“IPTV”) advertising, Internet Radio advertising, virtual worlds advertising. Advertisers may wish to utilize multiple channels in their advertising campaign.

### SUMMARY

A system is disclosed for providing advertisements across multiple channels. The system may include a processor, a memory and an interface. The memory may be operatively connected to the processor and the interface and may store advertisements and a request. The interface may communicate with a user. The processor may associate the advertisements with channels. An advertisement associated with a channel may be formatted for display on the channel. The processor may receive a request from the user via the interface. The processor may determine the channel associated with the request and retrieve an advertisement associated with the channel. The processor may provide the advertisement to the user via the interface.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a system for providing advertisements across multiple channels.

FIG. 2 is block diagram of a simplified view of a network environment implementing the system of FIG. 1 or other systems for providing advertisements across multiple channels.

FIG. 3 is a block diagram of an implementation of the system of FIG. 1 or other systems for providing advertisements across multiple channels.

FIG. 4 is an illustration of an advertisement hierarchy in the system of FIG. 1, or other systems for providing advertisements across multiple channels.

FIG. 5 is a flowchart illustrating operations of the system of FIG. 1, or other systems for providing advertisements across multiple channels.

FIG. 6 is a flowchart illustrating operations of creating an ad group associated with multiple channels in the system of FIG. 1, or other systems for providing advertisements across multiple channels.

FIG. 7 is a flowchart illustrating operations of a channel user in the system of FIG. 1, or other systems for providing advertisements across multiple channels.

FIG. 8 is a screenshot of a revenue generator's interface for creating an ad group in the system of FIG. 1, or other systems for providing advertisements across multiple channels.

FIG. 9 is a screenshot of a revenue generator's interface for choosing keywords in the system of FIG. 1, or other systems for providing advertisements across multiple channels.

FIG. 10 is a screenshot of a revenue generator's interface for setting an ad group bid in the system of FIG. 1, or other systems for providing advertisements across multiple channels.

FIG. 11 is a screenshot of a revenue generator's interface for reviewing an ad group in the system of FIG. 1, or other systems for providing advertisements across multiple channels.

FIG. 12 is an illustration a general computer system that may be used in a system for providing advertisements across multiple channels.

### DETAILED DESCRIPTION

A system and method, generally referred to as a system, relate to providing advertisements across multiple channels, and more particularly, but not exclusively, to providing an advertisement campaign management system supporting multiple advertisement delivery channels.

The system may enable an advertiser to maintain an advertisement campaign across multiple advertisement delivery channels, such as web, mobile, IPTV, Internet radio, virtual worlds, or generally any emerging delivery channel. The system may further allow an advertiser to run one campaign across all channels and/or configure a campaign specifically for each channel. In addition the system may allow an advertiser to configure their campaign for specific sub-channels within each channel.

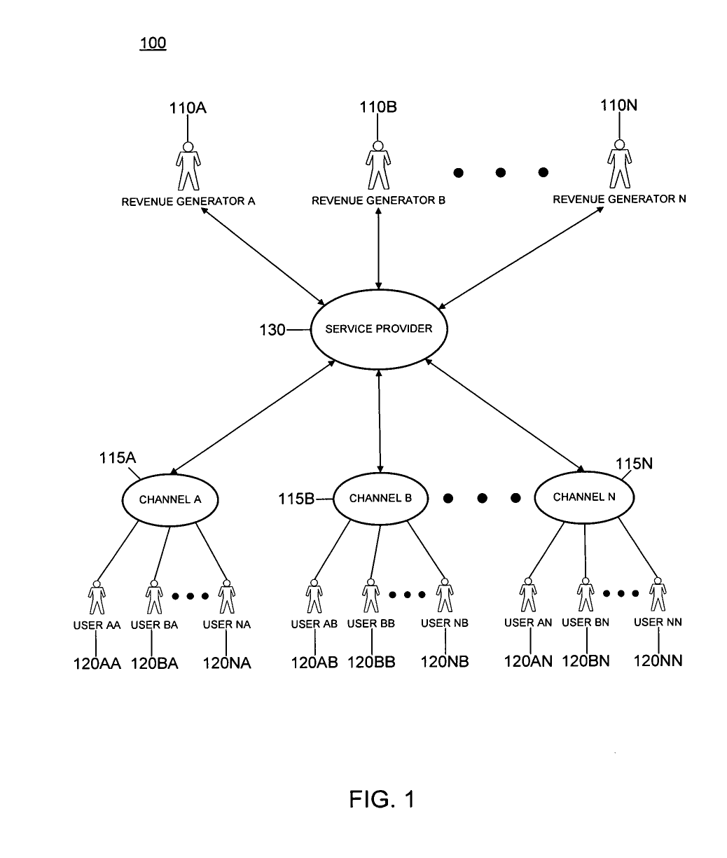

FIG. 1 provides a general overview of a system 100 for providing advertisements across multiple channels. Not all of the depicted components may be required, however, and some implementations may include additional components. Variations in the arrangement and type of the components may be made without departing from the spirit or scope of the claims as set forth herein. Additional, different or fewer components may be provided.

The system 100 may include one or more revenue generators 110A-N, such as advertisers, a service provider 130, such as an advertising services provider, one or more advertising channels 115A-N, such as web, mobile, or IPTV, and one or more users 120AA-NN, such as consumers, web users, or mobile subscribers. The service provider 130 may implement an advertising campaign management system incorporating an auction based and/or non-auction based advertisement serving system. The advertising system may enable the revenue generators 110A-N to maintain an advertising campaign across multiple advertising delivery channels 115A-N.

The revenue generators 110A-N may pay the service provider 130 to serve, or provide, advertisements of their goods or services, such as on-line advertisements, to the users 120AA-NN through the delivery channels 115A-N, such as web, mobile, and/or IPTV. The advertisements may include sponsored listings, banners ads, popup advertisements, video advertisements, audio advertisements, three-dimensional advertisements, or generally any method of attracting users 120AA-NN to the web site, mobile site, or virtual world site of the revenue generators 110A-N.

The channels 115A-N may be segmented into one or more sub-channels. The sub-channels may be a determinable segment of the channels 115A-N which may be used to target specific advertising campaigns. The revenue generators 110A-N may run their advertising campaign across one or more channels 115A-N and/or sub-channels. The revenue generators 110A-N may run one campaign across all the advertising channels 115A-N and/or sub-channels and/or the revenue generators 110A-N may specifically configure their campaign for each individual channel 115A-N and/or sub-channel. For example, the mobile channel may include a sub-channel for each mobile network operator, such as AT&T, VERIZON etc., the IPTV channel may include a sub-channel for each television network, such as ABC, NBC, ESPN, etc., and the Internet radio may include a sub-channel for each radio station.

The revenue generators 110A-N may provide the service provider 130 with individual advertisements formatted for each of the channels 115A-N and/or sub-channels. Alternatively or in addition the revenue generators 110A-N may provide an advertisement for one channel, such as the channel A 115A, and the service provider 130 may convert the advertisement into formats compatible with the additional channels 115B-N and/or sub-channels.

The service provider 130 may maintain one or more portals across each of the channels 115A-N, where the service provider 130 may provide advertisements of the revenue generators 110A-N to the users 120AA-NN. Alternatively or in addition the service provider 130 may maintain relationships with one or more partners within each channel 115A-N and/or sub-channel. For example, the service provider 130 may partner with web publishers in the web channel, mobile network operators in the mobile channel, television networks in the IPTV channel and/or Internet radio stations in the IPTV channel. The one or more partners may provide advertisements of the revenue generators 115A-N to the users 120AA-NN via the channels 115A-N. The service provider 130 may share revenue with the partners for providing advertisements to the users 120AA-NN.

The amount the revenue generators 110A-N may pay the service provider 130 for providing advertisements to the users 120AA-NN, and/or the amount the service provider 130 may share with the partners, may be based on one or more factors. These factors may include impressions, click throughs, conversions, and/or generally any metric relating to the advertisement and/or the behavior of the users 120AA-NN. The impressions may refer to the number of times an advertisement may have been provided to the users 120AA-NN. The click throughs may refer to the number of times the users 120AA-NN may have clicked through an advertisement to a web site, mobile web site or mobile landing page of one of the revenue generators 110A-N, such as the revenue generator A 110A. The conversions may refer to the number of times a desired action was taken by the users 120AA-NN after clicking though to a web site of the revenue generator A 110A. The desired actions may include submitting a sales lead, making a purchase, viewing a key page of the site, downloading a whitepaper, and/or any other measurable action. If the desired action is making a purchase, then the revenue generator A 110A may pay the service provider 130 a percentage of the purchase.

The users 120AA-NN may utilize the services of the service provider 130 through web applications, mobile applications or standalone applications, such as an IPTV browser. The users 120AA-NN may be consumers of goods or services who may be searching for a business, such as the business of one of the revenue generators 110A-N. Alternatively or in addition the users 120AA-NN may be machines or other servers. The users 120AA-NN may need a user identifier or identification (“user ID”) to access the services of the service provider 130. In order to obtain a user ID the users 120AA-NN may need to supply information describing themselves to the service provider 130, such as the location, gender, or age of the users 120AA-NN, or generally any information that may be required for the users 120AA-NN to utilize the services provided by the service provider 130. The service provider 130 may collect user behavior data from the users 120AA-NN when they are logged in, such as queries searched for by the users 120AA-NN, links clicked on by the users 120AA-NN, IPTV shows watched by the users 120AA-NN, and/or any user interactions with the services provided by the service provider 130. The service provider 130 may also use cookies, such as a browser cookie, to collect behavior data of the users 120AA-NN who are not logged in or who are not otherwise identifiable.

The service provider 130 may serve advertisements to the users 120AA-NN relevant to the collected user behavior data. For example, if a user AA 120AA performed searches for sports topics, watched sports IPTV shows, or viewed sports related media or articles, the service provider 130 may serve a sports related ad to the user AA 120AA. The revenue generators 110A-N may identify categories to associate their advertisements with, such as sports. Alternatively or in addition, the service provider 130 may perform content matching on the advertisements of the revenue generators 110A-N and identified interests of the user AA 120AA, such as sports.

In the system 100, the revenue generators 110A-N may interact with the service provider 130, such as via a web application. The revenue generators 110A-N may send information, such as billing, website or mobile site and advertisement information, to the service provider 130 via the web application. The web application may include a web browser or other application such as any application capable of displaying web content. The application may be implemented with a processor such as a personal computer, personal digital assistant, mobile phone, or any other machine capable of implementing a web application.

The users 120AA-NN may also interact individually with the service provider 130, through the channels 115A-N, such as via a computer, a mobile phone, an Internet television, or any device capable of communicating with the service provider 130 via any of the channels 115A-N. The service provider 130 may communicate data to the revenue generators 110A-N and the users 120AA-NN over a network. The following examples may refer to a revenue generator A 110A as an online advertiser; however the system 100 may apply to any revenue generators 110A-N who may desire to provide advertisements to users 120AA-NN on any of the channels 115A-N.

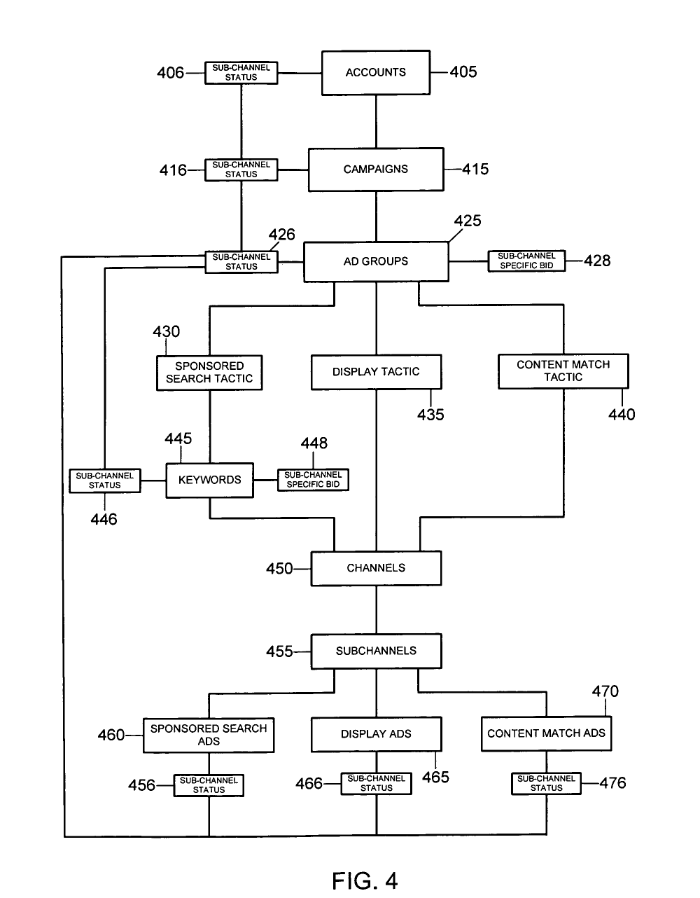

A revenue generator A 110A may maintain one or more accounts with the service provider 130. For each account the revenue generator A 110A may maintain one or more campaigns, and for each campaign the revenue generator A 110A may maintain one or more ad groups. An ad group may include one or more keywords, one or more bids, and one or more advertisements. The account hierarchy may be described in more detail in FIG. 4 below.

More detail regarding the aspects of auction-based systems, as well as the structure, function and operation of the service provider 130, as mentioned above, can be found in U.S. patent application Ser. No. 10/625,082, filed on Jul. 22, 2003, entitled, “TERM-BASED CONCEPT MARKET”; U.S. patent application Ser. No. 10/625,000, file on Jul. 22, 2003, entitled, “CONCEPT VALUATION IN A TERM-BASED CONCEPT MARKET” filed on Jul. 22, 2003; U.S. patent application Ser. No. 10/625,001, filed on Jul. 22, 2003, entitled, “TERM-BASED CONCEPT INSTRUMENTS”; and U.S. patent application Ser. No. 11/489,386, filed on Jul. 18, 2006, entitled, “ARCHITECTURE FOR AN ADVERTISEMENT DELIVERY SYSTEM,” all of which are hereby incorporated herein by reference in their entirety. The systems and methods herein associated with ad campaign management may be practiced in combination with methods and systems described in the above-identified patent applications incorporated by reference.

Furthermore, the service provider 130 may generate reports based on the data collected from the users 120AA-NN and communicate the reports to the revenue generators 110A-N to assist the revenue generators 110A-N in measuring the effectiveness of their advertising. The reports may indicate the number of times the users 120AA-NN were provided with advertisement of the revenue generators 110A-N, the number of times an advertisement of the revenue generators 110A-N was clicked on by the users 120AA-NN, or generally any information useful to the revenue generators 110A-N. There may be a separate report for each channel 115A-N and/or sub-channel the advertisement of the revenue generator A 110A was provided on. The reports may also generally indicate any data that may assist the revenue generators 110A-N in measuring the effectiveness of their advertising campaign across each of the channels 115A-N and/or sub-channels.

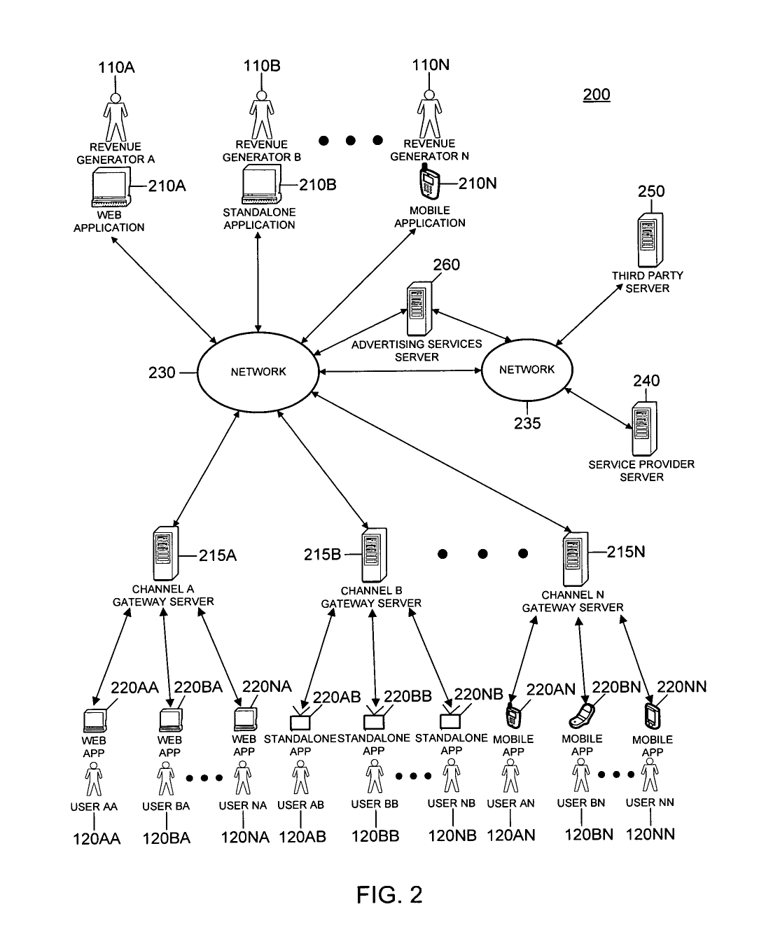

FIG. 2 provides a simplified view of a network environment implementing a system 200 for providing advertisements across multiple channels. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The system 200 may include one or more web applications, standalone applications and mobile applications 210A-N, 220AA-NN, which may be collectively or individually referred to as client applications. The system 200 may also include one or more channel gateway servers 215A-N, a network 230, a network 235, the service provider server 240, a third party server 250, and an advertising services server 260.

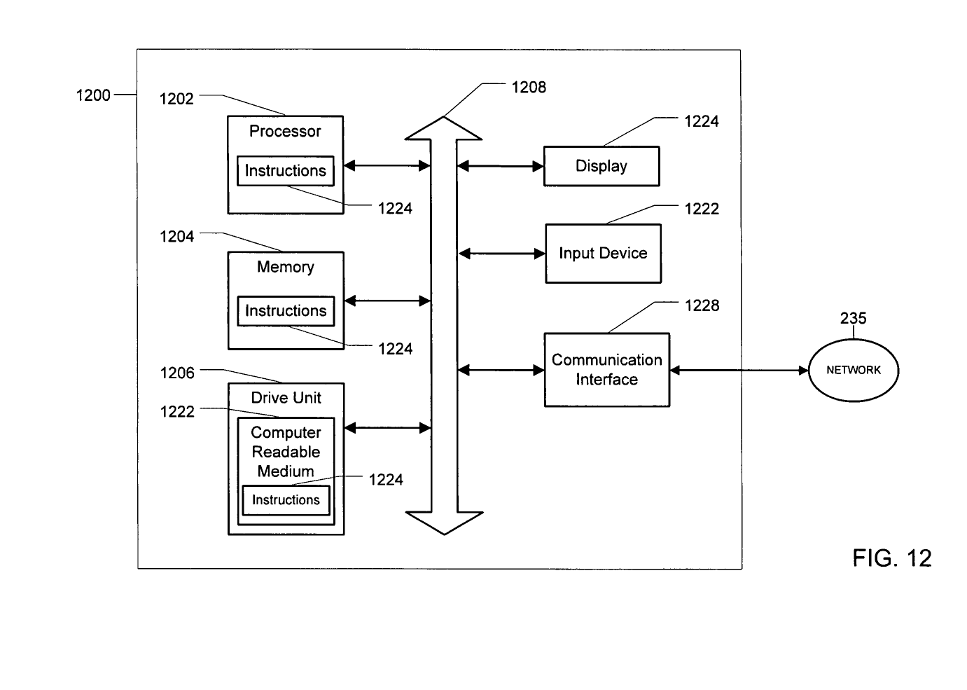

Some or all of the advertisement services server 260, service provider server 240, and third-party server 250 may be in communication with each other by way of network 235 and may be the system or components described below in FIG. 12. The advertisement services server 260, third-party server 250 and service provider server 240 may each represent multiple linked computing devices. Multiple distinct third party servers, such as the third-party server 250, may be included in the system 200. The third-party server 250 may be a channel gateway server 215A-N or a server associated with, or in communication with a channel gateway server 215A-N.

The channel gateway servers 215A-N may include one or more network access points for each of the channels 115A-N. In the case of the web channel the channel gateway servers 215A-N may be the service provider server 240. In the mobile channel the channel gateway servers 215A-N may be one or more mobile network operators (“MNOs”), such as AT&T, VERIZON, or SPRINT. In the IPTV channel the channel gateway servers 215A-N may be the systems providing IPTV service.

The networks 230, 235 may include wide area networks (WAN), such as the internet, local area networks (LAN), campus area networks, metropolitan area networks, or any other networks that may allow for data communication. The network 230 may include the Internet and may include all or part of network 235; network 235 may include all or part of network 230. The networks 230, 235 may be divided into sub-networks. The sub-networks may allow access to all of the other components connected to the networks 230, 235 in the system 200, or the sub-networks may restrict access between the components connected to the networks 230, 235. The network 235 may be regarded as a public or private network connection and may include, for example, a virtual private network or an encryption or other security mechanism employed over the public Internet, or the like.

The revenue generators 110A-N may use a web application 210A, standalone application 210B, or a mobile application 210N, or any combination thereof, to communicate to the service provider server 240, such as via the networks 230, 235. The service provider server 240 may communicate to the revenue generators 110A-N via the networks 230, 235, through the web applications, standalone applications or mobile applications 210A-N.

The users 120AA-NN may also use a web application 210A, standalone application 210B, or a mobile application 210N, or any combination thereof, to communicate to the service provider server 240 via the channel gateway servers 215A-N and the networks 230, 235. The service provider server 240 may communicate to the users 120AA-NN via the networks 230, 235 and the channel gateway servers 215A-N.

The web applications, standalone applications, and mobile application 210A-N, 220AA-NN may be connected to the network 230 in any configuration that supports data transfer. This may include a data connection to the network 230 that may be wired or wireless. The web applications 210A, 220AA-NA, may run on any platform that supports web content, such as a web browser or a computer, a mobile phone, personal digital assistant (PDA), pager, network-enabled television, digital video recorder, such as TIVO®, automobile and/or any appliance capable of data communications.

The standalone applications 210B, 220AB-NB may include an IPTV browser, an Internet radio browser, or generally any networked application providing content to the users 120AA-NN. The standalone applications 210B, 220AB-NB may run on a machine that may have a processor, memory, a display, a user interface and a communication interface. The processor may be operatively connected to the memory, display and the interfaces and may perform tasks at the request of the standalone applications 210B, 220AB-NB or the underlying operating system. The memory may be capable of storing data. The display may be operatively connected to the memory and the processor and may be capable of displaying information to the revenue generator B 110B and/or the users 120AB-NB. The user interface may be operatively connected to the memory, the processor, and the display and may be capable of interacting with a revenue generator B 110B and/or the users 120AB-NB. The communication interface may be operatively connected to the memory, and the processor, and may be capable of communicating through the networks 230, 235 with the service provider server 240, third party server 250 and advertising services server 260. The standalone applications 210B, 220AB-NB may be programmed in any programming language that supports communication protocols. These languages may include: SUN JAVA, C++, C#, ASP, SUN JAVASCRIPT, asynchronous SUN JAVASCRIPT, or ADOBE FLASH ACTIONSCRIPT, amongst others.

The mobile applications 210N, 220AN-NN may run on any mobile device which may have a data connection. The mobile applications 210N, 220AN-NN may be a web application 210A, 220AA-NA, a standalone application 210B, 220AB-NB, or a mobile browser. The mobile devices running the mobile applications 210N, 220AN-NN may be one of a broad range of electronic devices which may include mobile phones, PDAs, and laptops and notebook computers. The mobile devices may have a reduced feature set, such as a smaller keyboard and/or screen, and may be incapable of supporting a traditional web search.

The data connection of the mobile devices may be a cellular connection, such as a GSM/GPRS/WCDMA connection, a wireless data connection, an internet connection, an infra-red connection, a Bluetooth connection, or any other connection capable of transmitting data. The data connection may be used to connect directly to the network 230, or to connect to the network 230 through the channel gateway server N 215N.

The channels gateway servers 215A-N may control the access the network devices of the users 120AA-NN may have to the network 230. The channel gateway servers 215A-N may also control the technology supporting the respective network devices. This may affect aspects of the user experience, such as signal strength and availability, speed and billing mechanisms. For example, the channel gateway server A 215A may only allow the users 120AA-NA access to content provided by partners of the channel gateway server A 215A. Furthermore, the channels gateway servers 215A-N may only allow users 120AA-NN access to data in a specific format, such as HTML, WML, XHTML, NTT DOCOMO IMODE HTML, cHTML, IPTV, Internet radio, etc. Alternatively or in addition, the network devices of the users 120AA-NN may only support one of the aforementioned formats.

The service provider server 240 may include one or more of the following: an application server, a data source, such as a database server, a middleware server, and an advertising services server. The service provider server 240 may co-exist on one machine or may be running in a distributed configuration on one or more machines. The service provider server 240 may collectively be referred to as the server. The service provider server 240 may receive requests from the users 120AA-NN and the revenue generators 110A-N and may serve content to the users 120AA-NN and revenue generators 110A-N based on their requests, such as web pages, advertisements, mobile pages, etc.

The third party server 250 may include one or more of the following: an application server, a data source, such as a database server, a middleware server, and an advertising services server. The third party server 250 may co-exist on one machine or may be running in a distributed configuration on one or more machines. The advertising services server 260 may provide a platform for the inclusion of advertisements in pages, such as web pages or mobile pages. The advertisement services server 260 may be used for providing advertisements that may be provided to the users 120AA-NN.

The service provider server 240, the third party server 250 and the advertising services server 260 may be one or more computing devices of various kinds, such as the computing device in FIG. 12. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web application 210A may employ HTTP to request information, such as a web page, from a web server, which may be a process executing on the service provider server 240 or the third-party server 250.

There may be several configurations of database servers, application servers, middleware servers and advertising services servers included in the service provider server 240 or the third party server 250. Database servers may include MICROSOFT SQL SERVER, ORACLE, IBM DB2 or any other database software, relational or otherwise. The application server may be APACHE TOMCAT, MICROSOFT IIS, ADOBE COLDFUSION, YAPACHE or any other application server that supports communication protocols. The middleware server may be any middleware that connects software components or applications. The application server on the service provider server 240 or the third party server 250 may serve pages, such as web pages to the users 120AA-NN and the revenue generators 110A-N. The advertising services server may provide a platform for the inclusion of advertisements in pages, such as web pages, mobile pages, segments of IPTV content, segments of Internet radio content, etc. The advertising services server 260 may also exist independent of the service provider server 240 and the third party server 250.

The networks 230, 235 may be configured to couple one computing device to another computing device to enable communication of data between the devices. The networks 230, 235 may generally be enabled to employ any form of machine-readable media for communicating information from one device to another. Each of networks 230, 235 may include one or more of a wireless network, a wired network, a local area network (LAN), a wide area network (WAN), a direct connection such as through a Universal Serial Bus (USB) port, and the like, and may include the set of interconnected networks that make up the Internet. The networks 230, 235 may include any communication method by which information may travel between computing devices.

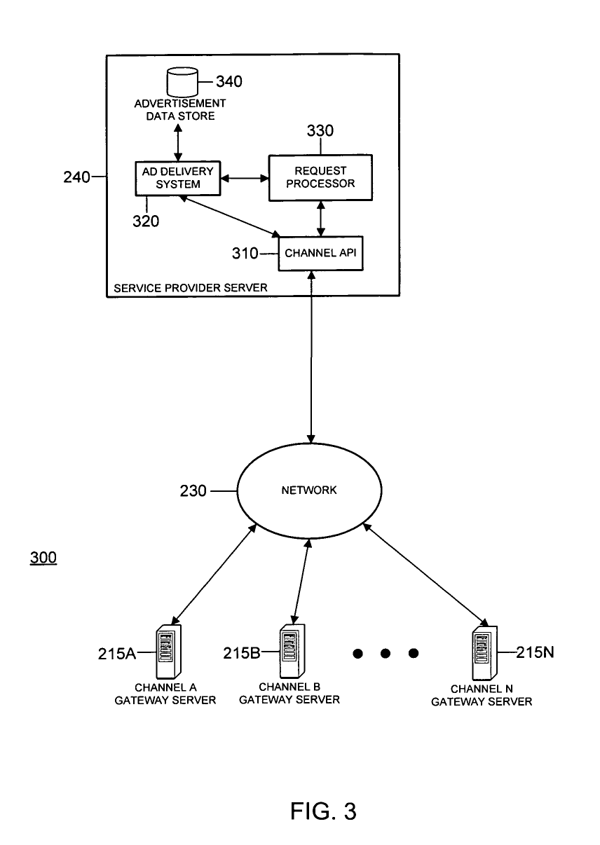

FIG. 3 illustrates a block diagram of an implementation of the system of FIG. 1 or other systems for providing advertisements across multiple channels. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The system 300 may include the service provider server 240, the network 230 and the channel gateway servers 215A-N. The service provider server 240 may include a channel application programming interface (“API”) 310, an ad delivery system 320, a request processor 330, and an ad data store 340.

In operation, the channel gateway servers 215A-N may be in communication with the service provider server 240 via the channel API 310. The users 120AA-NN may request content from the service provider server 240 via the channel gateway servers 215A-N. Alternatively or in addition the channel gateway servers 215A-N may request advertisements from the service provider server 240 via the channel API 310.

The service provider server 240 may receive a request from a channel gateway server A 215A, or a user AA 120AA via the channel API 310. The channel API 310 may communicate the request to the request processor 330. The request processor 330 may determine the channel the request originated from. Alternatively or in addition, the request processor 330 may determine the sub-channel, if any, the request originated from. The request processor 330 may communicate the request and the originating channel and/or sub-channel to the ad delivery system 320. The ad delivery system 320 may process the request to determine a set of criteria to use in retrieving an advertisement from the advertisement data store 340. The processing of the request may include generating content match keywords from the content of the request, or determining search keywords related to the request. Alternatively or in addition the ad delivery system 320 may determine whether the request can be processed to determine the requesting user. If the requesting user is identifiable, the historical behavior associated with their user ID may be used to target an advertisement.

The ad delivery system 320 may request an advertisement from the advertisement data store 340, targeted to the request and the originating channel. For example, if the originating channel is the IPTV channel, the ad delivery system 320 may request an advertisement related to the content of the current IPTV broadcast. If the originating channel includes one or more sub-channels, the ad delivery system 320 may retrieve an advertisement targeted to the specific sub-channel being viewed. The ad delivery system 320 may determine whether the advertisement is formatted properly for the channel and/or sub-channel. If the advertisement is not properly formatted for the channel and/or sub-channel the ad delivery system 320 may format the advertisement for the channel and/or sub-channel.

The ad delivery system 320 may communicate the retrieved advertisement to the channel API 310. The channel API 310 may communicate the advertisement to the requesting user via the originating channel. The requesting user may interact with the advertisement via their network device.

FIG. 4 illustrates an advertisement hierarchy in the system of FIG. 1 or other systems for providing advertisements across multiple channels. Not all of the depicted components may be required, however, and some implementations may include additional components not shown in the figure. Variations in the arrangement and type of the components may be made without departing from the spirit or scope of the claims as set forth herein. Additional, different or fewer components may be provided.

A revenue generator A 110A may maintain an account 405 with the service provider 130. The account 405 may include one or more advertising campaigns 415. Each advertising campaign 415 may include one or more ad groups 425. The ad groups 425 may include one or more distribution tactics 430, 435, 440. For example, the distribution tactics may include a sponsored search tactic 430, a display tactic 435, a content match tactic 440, and/or other distribution tactics which may emerge. The sponsored search tactic 430 may include one or more keywords 445. The keywords 445 may relate to the particular advertising campaign 415. The keywords 445 may be shared across all of the channels 450, such as the web channel, the mobile channel, the IPTV channel, the Internet radio channel, or other emerging advertising channels. The channels 450 may include one or more sub-channels 455. For example, in the IPTV channel, the sub-channels may include one or more networks which may provide IPTV programming, such as NBC, CBS, ABC, FOX, etc.

The revenue generators 110A-N may provide individual advertisements 460, 465, 470 for each of the channels 450 and/or sub-channels 455. The advertisements may be formatted specific to the particular channel 450 and/or sub-channel 455. The advertisements 460, 465, 470 may be separated based on the distribution tactics 430, 435, 440. The sponsored search ads 460 may include one or more advertisements that may be displayed in conjunction with a search engine. The search engine may be an Internet search engine, a mobile search engine, a virtual world search engine, or any delivery channel that may incorporate a search engine. The content match ads 470 may be advertisements which may be displayed in relation to matching content. The display ads 465 may be advertisements formatted for display to the users 120AA-NN, such as a banner ad, a video ad, or generally any display ad. The display ads 465 may be displayed to the users 120AA-NN in a channel that supports display, such as mobile, web, IPTV, etc.

In operation the revenue generators 110A-N may select one or more channels 450 and/or sub-channels 455 to display their advertisements on. The revenue generators 110A-N may be able to place sub-channel specific bids 428 for the different channels 450 and/or sub-channels 455 at the ad group level 425. The revenue generators 110A-N may be able to select which channels 450 are active and which are inactive by setting the sub-channel status 406, 416, 426, 446, 456, 466, 476. The revenue generators 110A-N may be able to create advertisements 460, 465, 470 specific to each channel 450 and/or sub-channel 455. The revenue generators 110A-N may be able to specify budgets at the channel level 450 and/or the sub-channel level 455.

At the account level 405 the revenue generators 110A-N may be able to set a sub-channel status 406 of on or off for each of the channels 450 and/or sub-channels 455 regardless of the status of the account 405 itself. By default the channels 450 and/or sub-channels 455 may be set to on unless the revenue generators 110A-N indicate otherwise. The change of the sub-channel status 406 at the account level 405 may not impact the channel status settings at the other levels. The revenue generators 110A-N may change the sub-channel status 406 at the account level 405, but the change does not flow down to the campaigns 415 and/or the ad groups 425. If the channel status is set to off at a higher level, the status may have an overriding effect on the lower levels. If a revenue generator A 110A sets the sub-channel status 406 of a channel to off at the account level 405, then even if the channel status is set to on at any of the lower levels the advertisements will not be shown. The channel status must be set to on at all of the levels for any ads to be served to the users 120AA-NN for the channels 450 and/or sub-channels 455.

At the campaign level 415 the revenue generators 110A-N may be able to set a sub-channel status 416 of on or off for each of the channels 450 and/or sub-channels 455 regardless of the status of the campaign 415 itself. By default the sub-channels status 416 may be set to on unless the revenue generators 110A-N indicate otherwise. The change of the sub-channel status 416 at the campaign level 415 may not impact the channel status settings at the other levels. The revenue generators 110A-N may change the sub-channel status 416 at the campaign level 415, but the change does not flow to the account level 405 and/or the ad groups 425. If the channel status is set to off at one of the levels, the status may have an overriding effect on the lower levels. If a revenue generator A 110A sets a sub-channel status 416 to off at the campaign level 415, then even if the channel status is set to on at any of the lower levels the advertisements will not be shown. The channel status must be set to on at all of the levels for any ads to be served to the users 120AA-NN for the channels 450 and/or sub-channels 455.

At the ad group level 425 the revenue generators 110A-N may be able to set a sub-channel status 426 of on or off for each of the channels 450 and/or sub-channels 455 regardless of the status of the ad group 425 itself. The revenue generators 110A-N may enable or disable the channels 450 and/or sub-channels 455 on a new ad group 425 or on an existing ad group 425. By default the web channel should be set to on and the other channels 450 and/or sub-channels 455 should be set to off. The change of the sub-channel status 426 at the ad group level 425 may not impact the channel status settings at the other levels. If the channel status is set to off at one of the levels, the status may have an overriding effect on the lower levels. If a revenue generator A 110A sets a channel to off at the ad group level 425, then no ads from that ad group 425 may be served. The sub-channel status 426 at the ad group level 425 must be set to on for any ads for the channels 450 and/or sub-channels 455.

The keywords 445 may not have a channel status. The keywords 445 within an ad group 425 may be shared across all of the channels 450 and sub-channels 455. If a keyword has a status of on then the keyword is available for all of the channels 450 and/or sub-channels 455. If the keyword status is set to off then the keyword is not available for any of the channels 450 and/or sub-channels 455.

The ads 460, 465, 470 may be specific to a particular channel 450 and/or sub-channel 455. The revenue generator A 110A may be able to set a sub-channel status 456 of on or off for the sponsored search ads 460 regardless of the status of the sponsored search ads 460 themselves. If the sub-channel status 456 of a sponsored search ad 460 is set to off for a channel 450 and/or sub-channel 455, then the sponsored search ad 460 may not be available in the channel 450 and/or sub-channel 455. The revenue generator A 110A may be able to set a sub-channel status 466 of on or off for the display ads 465 regardless of the status of the display ads 465 themselves. If the sub-channel status 466 of a display ad 465 is set to off for a channel 450 and/or sub-channel 455, then the display ad 465 may not be available in the channel 450 and/or sub-channel 455. The revenue generator A 110A may be able to set a sub-channel status 476 of on or off for the content match ads 470 regardless of the status of the content match ads 470 themselves. If the sub-channel status 476 of a content match ad 470 is set to off for a channel 450 and/or sub-channel 455, then the content match ad 470 may not be available in the channel 450 and/or sub-channel 455.

The sub-channels 455 may differ from one another in one or more ways, including the technology of the sub-channels 455, such as transmission, distribution, throughput, etc. the geographic coverage of the sub-channels 455, such as continent, country, region, etc., the demographics of the users 120AA-NN, the device type supported by the sub-channels 455, such as the screen size, ease of navigation, level of interaction of the sub-channels 455, the browser technology of the sub-channels 455, and the policies and guidelines regarding availability of, and user experience with the content. The revenue generators 110A-N may select a set of sub-channels 455 that may be used each time a new campaign 415 and/or ad group 425 is created. The status of the channels 450 and/or sub-channels 455 may indicate to the system 100 whether to provide advertisements to users 120AA-NN on the channels 450 and/or sub-channels 455.

The system 100 may store/maintain data relating to the sub-channels 455 in a data store. Specific attributes may be associated with each sub-channel 455. For example, in the case of the mobile channel, the sub-channels 455 may be the individual mobile carriers. The attributes may be the carrier name, such as SPRINT, NEXTEL, VERIZON, the carrier code, such as SP, NX, VZ, the network technology, such as GSM, CDMA, GSM, the supported devices, and the supported mark-up languages. Market-specific sub-channels 455 may be created and maintained. The service provider 130 may obtain the attributes of the sub-channels 455 from a third party, such as the third party server 250.

Channels 450 and/or sub-channels 455 may be created and/or deleted. The revenue generators 110A-N may be notified when a new channel 450 and/or sub-channel 455 is created and/or deleted. The existing revenue generators 110A-N may be able to view the sub-channel 455 for a limited amount of time after a sub-channel 455 is deleted; however the system 100 may stop serving advertisements on the sub-channel 455 immediately. The sub-channels 455 may be renamed and/or rebranded. The revenue generators 110A-N may be notified of any renaming and/or rebranding of the sub-channels 455.

The system 100 may allow for channel specific tactics to be set. For example, the tactics may include the sponsored search tactic 430, the display tactic 435 and/or the content match tactic 440. The tactics 430, 435, 440 may be set at the account level 405. The revenue generators 110A-N may set bids at the ad group level 425. The default bids at the ad group level 425 may apply to all of the selected sub-channels 455 and all of the keywords 445 in the ad group 425. The revenue generators 110A-N may be presented with a recommended bid for a given channel 450 and/or sub-channel 455. The revenue generators 110A-N may set sub-channel specific bids 428 at the ad group level 425 which override the default bids. The revenue generators 110A-N may also set sub-channel specific bids 448 at the keyword level 445. Alternatively or in addition the revenue generators 110A-N may set sub-channel specific bids 455 which may override the sub-channel specific bids 448 at the keyword level 445.

The system 100 may determine the bid for a sponsored search tactic 430 keyword by identifying the ad group 425 where the keyword 445 resides. The system 100 first attempts to use a keyword level 445 sub-channel specific bid 448. If a keyword level 445 sub-channel specific bid 448 doesn't exist the system 100 may use an ad group level 425 sub-channel specific bid 428. If an ad group level 425 sub-channel specific bid 428 doesn't exist the system 100 may use the ad group level 425 default bid.

The revenue generators 110A-N may select keyword specific uniform resource locator (“URL”) overrides. The keyword-level 445 URL overrides may be applicable to all selected sub-channels 455 in the market. Sub-channel specific overrides may be allowed to the keyword-level URL override. The editorial status of the keywords 445 may be determined on a per channel 450 basis. For example a keyword 445 may be accepted for the web, but rejected for the mobile, and vice-versa. The revenue generators 110A-N may be able to set the sub-channel 455 specific editorial status of each keyword 445 in an ad group 425. Each ad may be sub-channel specific or may have one or more sub-channels 455 that it applies to. The advertisements 460, 465, 470 and keywords 445 may be rejected for channel 450 specific reasons, and/or sub-channel 455 specific reasons,

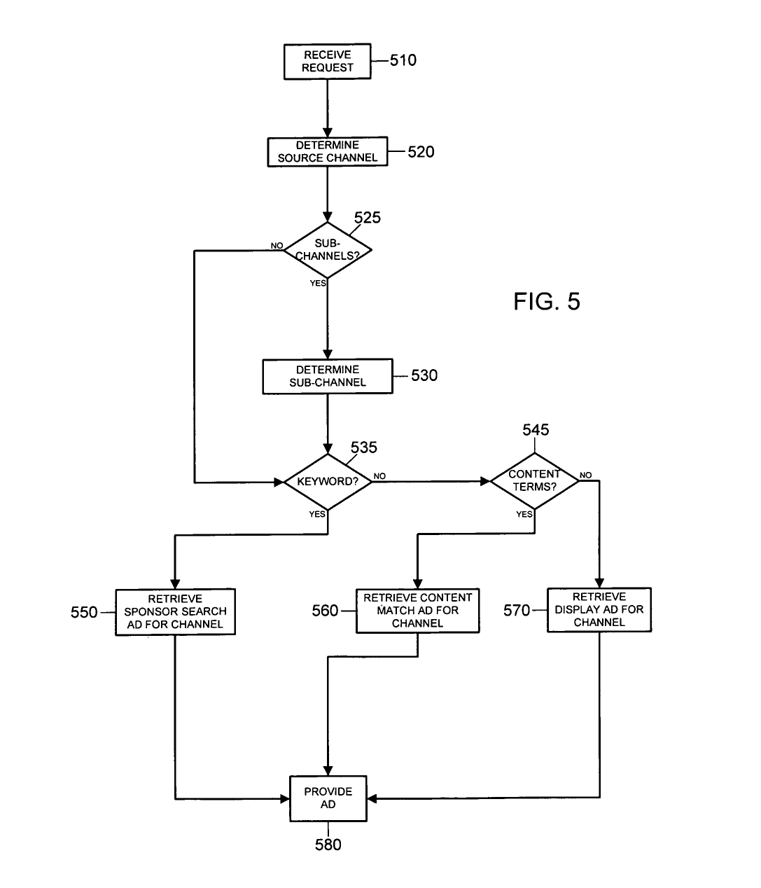

FIG. 5 is a flowchart illustrating operations of the system of FIG. 1, or other systems for providing advertisements across multiple channels. At block 510 the system 100 may receive a request for an advertisement from a channel provider gateway server 215A-N or from a network device of one of the users 120AA-NN, such as the user AA 120AA. At block 520 the system 100 may determine the channel 450 originating the request, such as the web, mobile, IPTV, etc. At block 525 the system 100 may determine whether sub-channels 455 exist for the determined channel 450. If sub-channels 455 exist for the determined channel 450 the system 100 may move to block 530. At block 530 the system 100 may determine the sub-channel 455 associated with the request. If at block 525 there is no sub-channel 455 associated with the request then the system 100 may move to block 535.

At block 535 the system 100 may determine whether a keyword 445 is associated with the request. If a keyword 445 is associated with the request the system 100 may move to block 550. At block 550 the system 100 may retrieve a sponsored search advertisement 460 for the determined channel 450 and/or sub-channel 455 relating to the keyword 445. At block 580 the system 100 may provide the advertisement 460 to the user AA 120AA.

If at block 535 there is no keyword 445 associated with the request, then the system 100 may move to block 545. At block 545 the system 100 may determine whether any terms describing the content associated with the request may be determined from the request. If terms describing the content may be retrieved from the request then the system 100 may move to block 560. At block 560 the system 100 may retrieve a content match advertisement 470 for the channel 450 and/or sub-channel 455 related to the content terms. At block 580 the advertisement 470 may be provided to the user AA 120AA. If at block 545 no terms describing the content of the request can be determined from the request, the system 100 may move to block 570. At block 570 the system 100 may retrieve a display ad 465 for the channel 450 and/or sub-channel 455. At block 580 the advertisement 465 may be provided to the user AA 120AA. Alternatively or in addition the display ads 465 may be retrieved based on a keyword or content associated with the request, such as a keyword match or a content match.

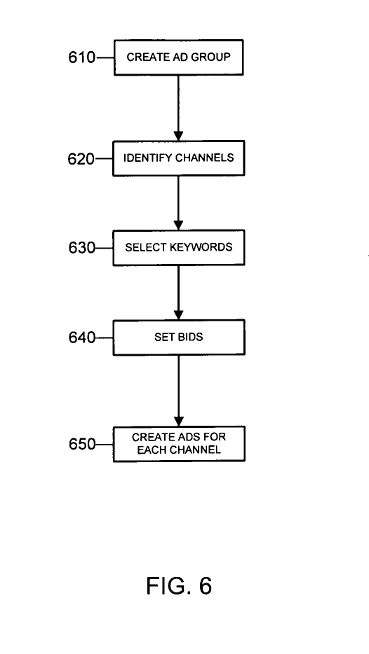

FIG. 6 is a flowchart illustrating operations of creating an ad group associated with multiple channels in the system of FIG. 1, or other systems for providing advertisements across multiple channels. At block 610 the revenue generator A 110A may create an ad group 425 for a given campaign 415. At block 620 the revenue generator A 110A may identify the channels 450 and/or sub-channels 455 to associate with the ad group 425. At block 630 the revenue generator A 110A may select keywords 445 to associate with the ad group 425. At block 640 the revenue generator A 110A may set bids for the ad group 425. The revenue generator A 110A may set specific bids for the ad group 425, for the keywords 445, for the channel 450 and/or for the sub-channels 455. At block 650 the revenue generator A 110A may create individual advertisements for each channel 450 and/or sub-channel 455. Alternatively or in addition the same advertisements may be applied across one or more channels 450 and/or sub-channels 455.

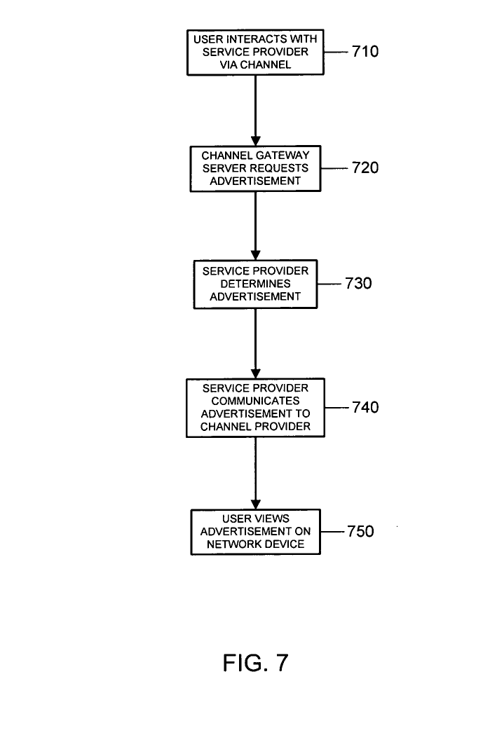

FIG. 7 is a flowchart illustrating operations of a channel user in the system of FIG. 1, or other systems for providing advertisements across multiple channels. At block 710 one of the users 120AA-NN, such as the user AA 120AA, may interact with the service provider 130 via one of the channels 115A-N, such as the channel A 115A. At block 720 the channel gateway server A 215A may request an advertisement from the service provider server 240. At block 730 the service provider server 240 may determine an advertisement associated with the channel A 115A. At block 740 the service provider server 240 may communicate the advertisement to the channel gateway server A 215A. At block 750 the channel gateway server A 215A may provide the advertisement to the user AA 120AA.

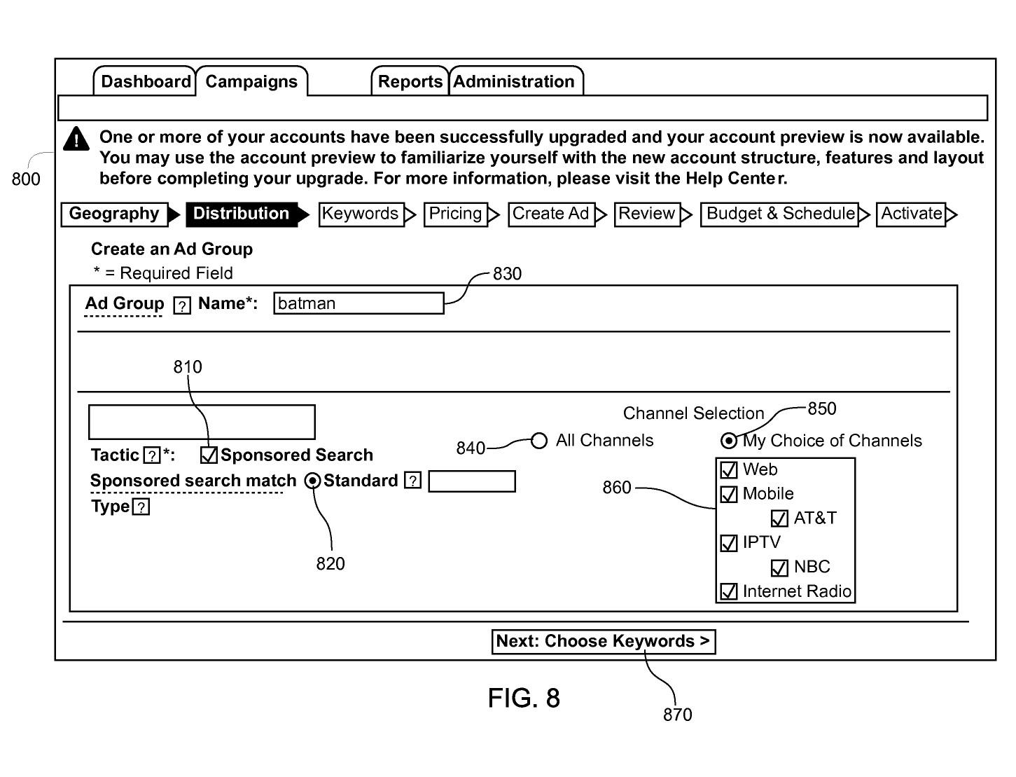

FIG. 8 is a screenshot of a revenue generator's interface 800 for creating an ad group 425 in the system of FIG. 1, or other systems for providing advertisements across multiple channels. The interface 800 may include an ad group name field 830, one or more advertising tactic checkboxes 810, a match type selector 820, an all channels selector 840, an channel selector 850, individual channel checkboxes 860, and a next button 870.

In operation, one of the revenue generators 110A-N, such as the revenue generator A 110A, may interact with the interface 800 to create an ad group 425. The revenue generator A 110A may enter a name for the ad group 425 in the ad group name field 830. The revenue generator A 110A may select one or more advertising tactic checkboxes 810 to associate with the ad group 425. The advertising tactic may refer to the method of advertising, such as content matching, sponsored search, behavioral profiling, or generally any means for the revenue generator A 110A to attract the users 120AA-NN to their mobile and/or web properties and/or other network properties. Any advertising tactics available to the revenue generators 110A-N in traditional web advertising may also be available to the revenue generators 110A-N in the interface 800. Alternatively or in addition the interface 800 may provide the revenue generators 110A-N with the option of using channel specific advertising tactics, such as mobile messaging advertising, or mobile application advertising. If the revenue generator A 110A selects the sponsored search tactic the revenue generator A 110A may select the search match type to use in the match type selector 820. The match type may be advanced matching, or generally any other type of matching. The revenue generator A 110A may select to target the ad group 425 to all channels 450 by using the all channels selector 840. The revenue generator A 110A may target the ad group 425 to individual channels 450 by selecting the individual channel selector 850. The revenue generator A 110A may select one or more individual channels 450 and/or sub-channels 455 with the individual channels checkboxes 860.

Once the revenue generator A 110A has created the ad group 425 the revenue generator A 110A may click on the next button 870 to move to the next interface. If the revenue generator A 110A clicks on the next button 870 the system 100 may provide the revenue generator A 110A with the interface 900.

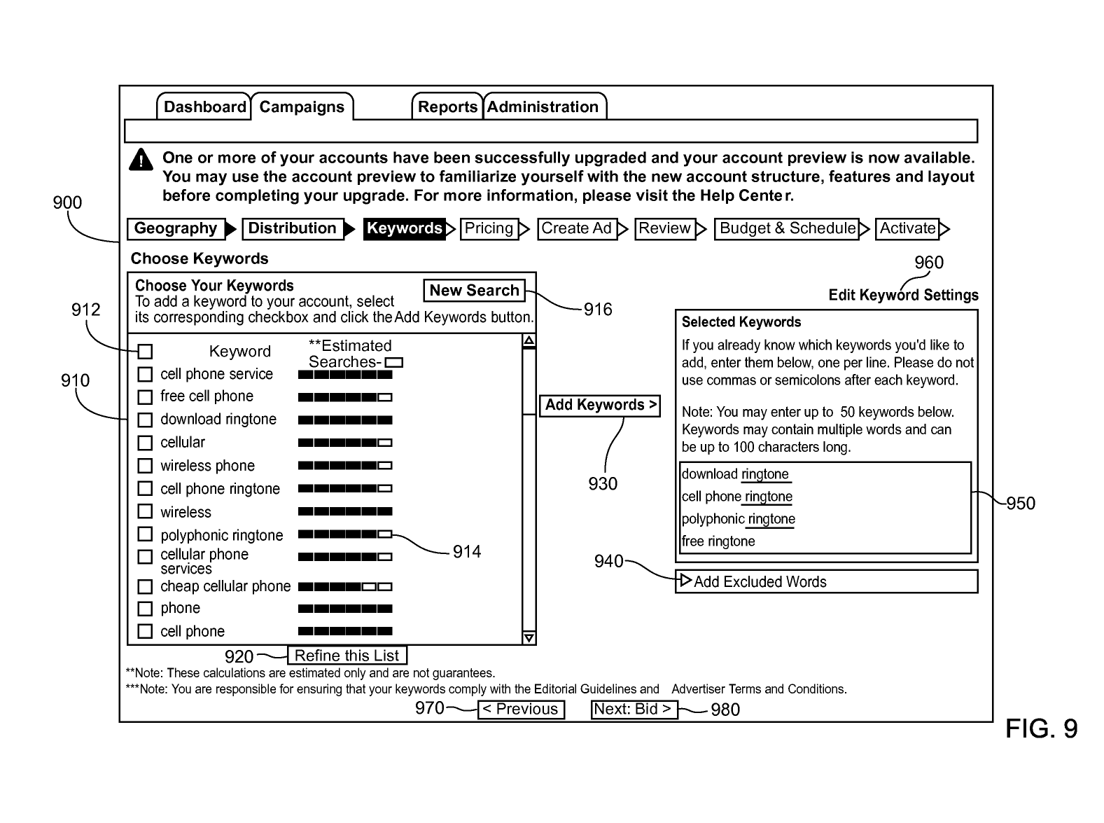

FIG. 9 is a screenshot of a revenue generator's interface 900 for choosing keywords 445 in the system of FIG. 1, or other systems for providing advertisements across multiple channels. The interface 900 may include keyword checkboxes 910, a new search button 916, estimated search bars 914, a refine list button 920, an add keywords button 930, an edit keyword settings link 960, a selected keyword box 950, an add excluded keywords button 940, a previous button 970, and a next button 980.

In operation the revenue generator A 110A may use the interface 900 to add keywords to the ad group 425. The keyword checkboxes 910 may be used to select a set of keywords to add to the ad group 425. The revenue generator A 110A may have used a search tool to search for one or more keywords 445 and the system 100 may have displayed the list of suggested keywords. The revenue generator A 110A may be able to submit a new keyword search by clicking on the new search button 916. The new search button 916 may provide the revenue generator A 110A with search text box for entering a new search query. Performing a new search may result in a new list of suggested search queries. The estimated search bars 914 may indicate the number of searches the revenue generator A 110A may expect to receive from the keyword 445. The revenue generator A 110A may click on the refine list button 920 to refine the list of keywords 445. The refine list button 920 may provide the revenue generator A 110A with a text field with the query used to generate the list of keywords 445. The revenue generator A 110A may the modify the original search query to refine the list of keywords 445.

The revenue generator A 110A may mark one or more keyword checkboxes 910 and then click on the add keywords button 930 to add the selected keywords 445 to the selected keyword box 950. The selected keyword box 950 may display all of the keywords 445 currently selected for the ad group 425. The revenue generator A 110A may edit the keyword settings by clicking on the edit keyword settings link 960. The revenue generator A 110A may exclude certain words from the selected keyword box 950. The revenue generator A 110A may re-add the excluded keywords by clicking on the add excluded keyword button 960.

Once the revenue generator A 110A has selected the keywords 445 to add to the ad group 425 the revenue generator A 110A may click on the next button 980 to move to the next interface, or the previous button 970 to move to the previous interface. If the revenue generator A 110A clicks on the next button 980, the system 100 may provide the revenue generator with the interface 1000. If the revenue generator A 110A clicks on the previous button 970, the system 100 may provide the revenue generator with the interface 800.

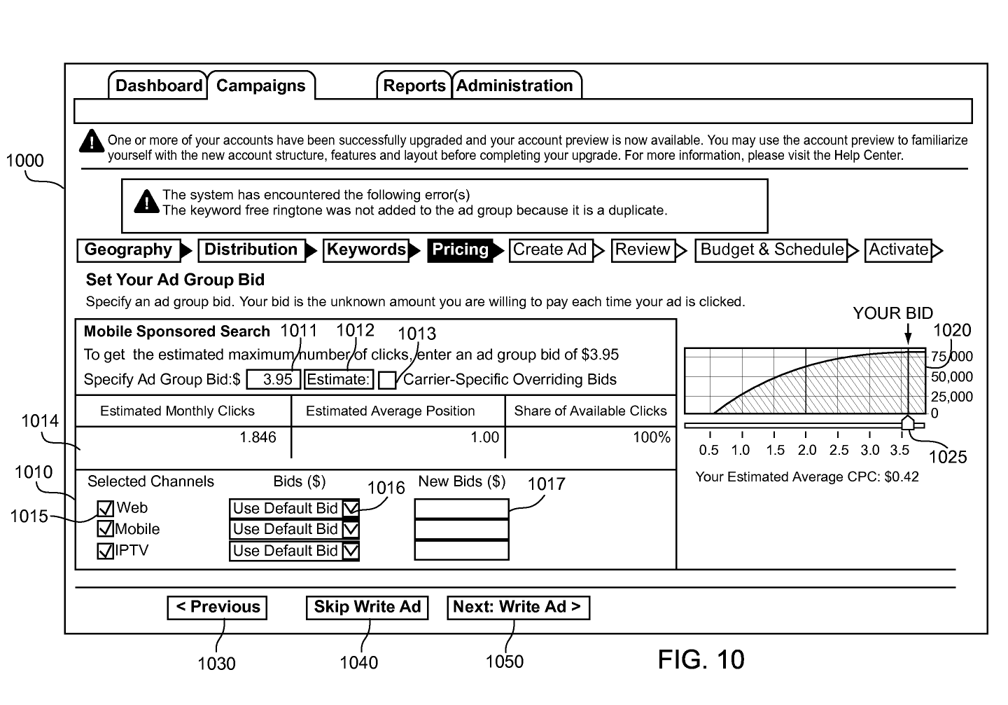

FIG. 10 is a screenshot of a revenue generator's interface 1000 for setting an ad group 425 bid in the system of FIG. 1, or other systems for providing advertisements across multiple channels. The interface 1000 may include an ad group bid field 1011, an estimate button 1012, a channel specific checkbox 1013, a estimated clicks display 1014, an estimated graph 1020, a slider bar 1025, an individual channel section 1010, a previous button 1030, a skip write ad button 1040, and a next button 1050. The individual channel section 1010 may include selected channel checkboxes 1015, bid drop downs 1016, and new bid text fields 1017.

In operation the revenue generator A 110A may use the interface 1000 to bid on ad groups 425. The revenue generator A 110A may place one bid across all of the channels 115A-N associated with an ad group 425, or may specify individual bids for each of the channels 115A-N associated with an ad group 425. The revenue generator A 110A may enter a bid in the ad group bid field 1011. The revenue generator A 110A may click on the estimate button 1012 to see the estimated monthly clicks for the bid, estimated average position for the bid and estimated share of available clicks for the bid in the estimated clicks display 1014. The estimated graph 1020 may show a graph of the estimated clicks for the bid. The revenue generator A 110A may be able to move the slider bar 1025 to view the estimated clicks for other bid amounts.

The revenue generator A 110A may set individual bids for each of the channels 115A-N associated with the ad group 425 by clicking on the channel specific checkbox 1013. The revenue generator A 110A may then enter individual bids for each of the channels 115A-N associated with the ad group 425 in the individual channel section 1010. The individual channel section 1010 may show each of the channels 15A-N associated by the revenue generator A 110A with the ad group 425 via the interface 800. The revenue generator A 110A may use the channel checkboxes 1015 to select which of the channels 15A-N to change the bid for. The bid drop downs 1016 may have several options for the revenue generator A 110A, such as “Use default bid”, “Set New Bid”, or generally any action relating to setting the bids. If the revenue generator A 110A selects the option in the drop down 1016 associated with setting a new bid, such as “Set New Bid,” then the revenue generator A 110A may set a new bid in the new bid text field 1017.

Once the revenue generator A 110A has identified bids for the channels 115A-N, the revenue generator A 110A may click on the next button 1050. The next button 1050 may present the revenue generator A 110A with an interface for creating one or more advertisements for the ad group 425. If the revenue generator A 110A already has advertisements created for the ad group 425, or otherwise does not wish to create advertisements for the ad group 425, the revenue generator A 110A may click on the skip write ad button 1040. If the revenue generator A 110A selects the skip write ad button 1040 the system 100 may provide the revenue generator A 110A with the interface 1100. If the revenue generator A 110A clicks on the previous button 1030, the system 100 may provide the revenue generator A 110A with the interface 900.

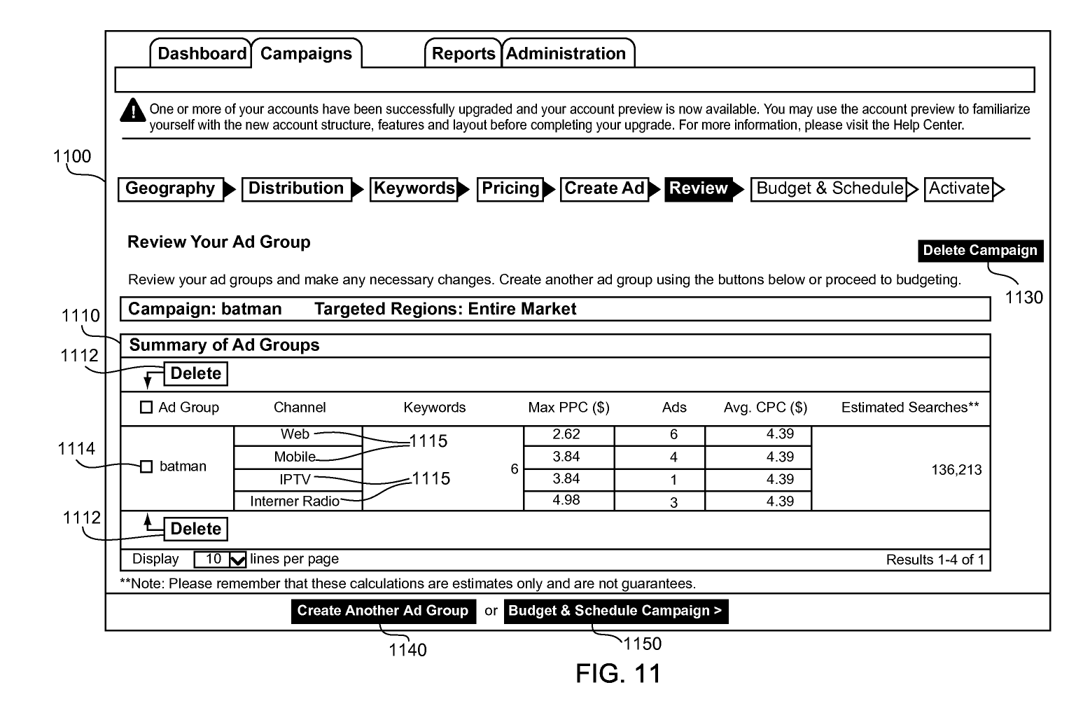

FIG. 11 is a screenshot of a revenue generator's interface 1100 for reviewing an ad group 425 in the system of FIG. 1, or other systems for providing advertisements across multiple channels. The interface 1100 may include a delete button 1112, an ad group checkbox 1114, a channel listing 1115, a delete campaign button 1130, a create another button 1140 and a budget button 1150.

In operation the revenue generator A 110A may review the ad groups 425 which have been created through the system 100. The interface 1100 may display data associated with each ad group 425 created by the revenue generator A 110A, such as a channel listing 1115 showing the channels 115A-N associated with the ad group 425, the number of keywords 445 associated with the ad group 425, the maximum bids for each channel 115A-N associated with the ad group 425, the number of advertisements associated with the ad group 425, the estimated average cost per click for each of the channels 115A-N, and the estimated number of searches for the ad group 425. The revenue generator A 110A may delete one or more of the ad groups 425 by checking the ad group checkbox 1114 associated with the ad group 425 and clicking on the delete button 1112. The revenue generator A 110A may delete the entire campaign 415 by clicking on the delete campaign button 1130.

Once the revenue generator A 110A has reviewed the ad groups 425 the revenue generator A 110A may click on the create another button 1140 to create another ad group 425. If the revenue generator A 110A clicks on the create another button 1140 the system 100 may provide the revenue generator A 110A with the interface 800. If the revenue generator A 110A clicks on the budget button 1150, the system 100 may provide the revenue generator A 110A with the an interface for setting a budget for the campaign 415. If the revenue generator A 110A clicks on either of the buttons 1140, 1150, the ad group 425 may be activated for the channels 115A-N selected by the revenue generator A 110A.

FIG. 12 illustrates a general computer system 1200, which may represent a service provider server 240, a third party server 250, an advertising services server 260, or any of the other computing devices referenced herein. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The computer system 1200 may include a set of instructions 1224 that may be executed to cause the computer system 1200 to perform any one or more of the methods or computer based functions disclosed herein. The computer system 1200 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 1200 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 1224 (sequential or otherwise) that specify actions to be taken by that machine. In a particular embodiment, the computer system 1200 may be implemented using electronic devices that provide voice, video or data communication. Further, while a single computer system 1200 may be illustrated, the term “system” shall also be taken to include any collection of systems or sub-systems that individually or jointly execute a set, or multiple sets, of instructions to perform one or more computer functions.

As illustrated in FIG. 12, the computer system 1200 may include a processor 1202, such as, a central processing unit (CPU), a graphics processing unit (GPU), or both. The processor 1202 may be a component in a variety of systems. For example, the processor 1202 may be part of a standard personal computer or a workstation. The processor 1202 may be one or more general processors, digital signal processors, application specific integrated circuits, field programmable gate arrays, servers, networks, digital circuits, analog circuits, combinations thereof, or other now known or later developed devices for analyzing and processing data. The processor 1202 may implement a software program, such as code generated manually (i.e., programmed).

The computer system 1200 may include a memory 1204 that can communicate via a bus 1208. The memory 1204 may be a main memory, a static memory, or a dynamic memory. The memory 1204 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 1204 may include a cache or random access memory for the processor 1202. Alternatively or in addition, the memory 1204 may be separate from the processor 1202, such as a cache memory of a processor, the system memory, or other memory. The memory 1204 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 1204 may be operable to store instructions 1224 executable by the processor 1202. The functions, acts or tasks illustrated in the figures or described herein may be performed by the programmed processor 1202 executing the instructions 1224 stored in the memory 1204. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 1200 may further include a display 1214, such as a liquid crystal display (LCD), an organic light emitting diode (OLED), a flat panel display, a solid state display, a cathode ray tube (CRT), a projector, a printer or other now known or later developed display device for outputting determined information. The display 1214 may act as an interface for the user to see the functioning of the processor 1202, or specifically as an interface with the software stored in the memory 1204 or in the drive unit 1206.

Additionally, the computer system 1200 may include an input device 1212 configured to allow a user to interact with any of the components of system 1200. The input device 1212 may be a number pad, a keyboard, or a cursor control device, such as a mouse, or a joystick, touch screen display, remote control or any other device operative to interact with the system 1200.

The computer system 1200 may also include a disk or optical drive unit 1206. The disk drive unit 1206 may include a computer-readable medium 1222 in which one or more sets of instructions 1224, e.g. software, can be embedded. Further, the instructions 1224 may perform one or more of the methods or logic as described herein. The instructions 1224 may reside completely, or at least partially, within the memory 1204 and/or within the processor 1202 during execution by the computer system 1200. The memory 1204 and the processor 1202 also may include computer-readable media as discussed above.

The present disclosure contemplates a computer-readable medium 1222 that includes instructions 1224 or receives and executes instructions 1224 responsive to a propagated signal; so that a device connected to a network 235 may communicate voice, video, audio, images or any other data over the network 235. The instructions 1224 may be implemented with hardware, software and/or firmware, or any combination thereof. Further, the instructions 1224 may be transmitted or received over the network 235 via a communication interface 1218. The communication interface 1218 may be a part of the processor 1202 or may be a separate component. The communication interface 1218 may be created in software or may be a physical connection in hardware. The communication interface 1218 may be configured to connect with a network 235, external media, the display 1214, or any other components in system 1200, or combinations thereof. The connection with the network 235 may be a physical connection, such as a wired Ethernet connection or may be established wirelessly as discussed below. Likewise, the additional connections with other components of the system 1200 may be physical connections or may be established wirelessly. In the case of a service provider server 240, a third party server 250, an advertising services server 260, the servers may communicate with users 120AA-NN and the revenue generators 110A-N through the communication interface 1218.

The network 235 may include wired networks, wireless networks, or combinations thereof. The wireless network may be a cellular telephone network, an 802.11, 802.16, 802.20, or WiMax network. Further, the network 235 may be a public network, such as the Internet, a private network, such as an intranet, or combinations thereof, and may utilize a variety of networking protocols now available or later developed including, but not limited to TCP/IP based networking protocols.

The computer-readable medium 1222 may be a single medium, or the computer-readable medium 1222 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 1222 may include a solid-state memory such as a memory card or other package that houses one or more non-volatile read-only memories. The computer-readable medium 1222 also may be a random access memory or other volatile re-writable memory. Additionally, the computer-readable medium 1222 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A method for providing advertisements across multiple channels, comprising:
associating a plurality of advertisements with a plurality of channels wherein an advertisement associated with a channel is formatted for display on the channel;
receiving a request from a user;
determining a channel in the plurality of channels associated with the request;
retrieving an advertisement associated with the channel; and
providing the advertisement to the user.

2. The method of claim 1 wherein retrieving an advertisement associated with the channel further comprises retrieving an advertisement associated with the channel and targeted to the request.

3. The method of claim 1 wherein the plurality of channels comprises at least one of a web channel, a mobile channel, an IPTV channel, and an Internet radio channel.

4. The method of claim 1 wherein at least one channel in the plurality of channels is associated with a plurality of sub-channels.

5. The method of claim 4 wherein the plurality of sub-channels comprises at least one of a mobile carrier, an IPTV network, and an Internet radio station.

6. A method for providing an interface for creating an ad group associated with a plurality of channels, comprising:
providing an interface enabling an advertiser to identify one or more keywords, a plurality of channels, and a plurality of advertisements;
associating the one more keywords, the plurality of advertisements, and the plurality of advertising channels; and
providing an advertisement in the plurality of advertisements to a user when the user accesses a network via a channel in the plurality of channels.

7. The method of claim 6 wherein the plurality of channels comprises at least one of a web channel, a mobile channel, an IPTV channel, and an Internet radio channel.

8. The method of claim 6 wherein an advertisement is formatted for display on the associated channel.

9. The method of claim 6 wherein at least one channel in the plurality of channels is associated with a plurality of sub-channels.

10. The method of claim 9 wherein the plurality of sub-channels comprises at least one of a mobile carrier, an IPTV network, and an Internet radio station.

11. A method for facilitating the display of advertisement campaign information for multiple channels, comprising:
organizing advertisement campaign information into one or more ad groups, wherein at least one ad group is associated with a plurality of channels; and
sending at least a portion of the advertisement campaign information to a user interface for display based at least in part on a channel in the plurality of channels.

12. The method of claim 11 wherein the plurality of channels comprises at least one of a web channel, a mobile channel, an IPTV channel, and an Internet radio channel.

13. The method of claim 11 wherein at least one channel in the plurality of channels is associated with a plurality of sub-channels.

14. The method of claim 13 further comprising associating at least one ad group with the plurality of sub-channels.

15. The method of claim 13 wherein the plurality of sub-channels comprises at least one of a mobile carrier, an IPTV network, and an Internet radio station.

16. A system for providing an interface for creating an ad group associated with a plurality of channels, comprising:
means for providing an interface enabling an advertiser to identify one or more keywords, a plurality of channels, and a plurality of advertisements;
means for associating the one more keywords, the plurality of advertisements, and the plurality of advertising channels; and
means for providing an advertisement in the plurality of advertisements to a user when the user accesses a network via a channel in the plurality of channels.

17. The system of claim 16 wherein the plurality of channels comprises at least one of a web channel, a mobile channel, an IPTV channel, and an Internet radio channel.

18. The system of claim 16 wherein an advertisement is formatted for display on the associated channel.

19. The system of claim 16 wherein at least one channel in the plurality of channels is associated with a plurality of sub-channels.

20. The system of claim 19 wherein the plurality of sub-channels comprises at least one of a mobile carrier, an IPTV network, and an Internet radio station.

21. A system for providing advertisements across multiple channels, comprising:
a memory to store a plurality of advertisements;
an interface operatively connected to the memory, the interface to communicate with a user; and
a processor operatively connected to the memory and the interface, the processor for running instructions, wherein the processor associates the plurality of advertisements with a plurality of channels, wherein an advertisement associated with a channel is formatted for display on the channel, receives a request from a user via the interface, determines the channel in the plurality of channels associated with the request, retrieves an advertisement associated with the channel, and provides the advertisement to the user via the interface.

22. The system of claim 21 wherein the processor is further operative to retrieve an advertisement associated with the channel and targeted to the request.

23. The system of claim 21 wherein the plurality of channels comprises at least one of a web channel, a mobile channel, an IPTV channel, and an Internet radio channel.

24. The system of claim 21 wherein at least one channel in the plurality of channels is associated with a plurality of sub-channels.

25. The system of claim 24 wherein the plurality of sub-channels comprises at least one of a mobile carrier, an IPTV network, and an Internet radio station.
